(19) United States
(12) Patent Application Publication
(10) Pub. No.: US 2023/0371441 A1
(43) Pub. Date: Nov. 23, 2023

(54) Removable Plant Pot Device

(71) Applicant: Carrie Beers, New Port Richey, FL (US)

(72) Inventor: Carrie Beers, New Port Richey, FL (US)

(21) Appl. No.: 18/311,472

(22) Filed: May 3, 2023

Related U.S. Application Data
(60) Provisional application No. 63/344,684, filed on May 23, 2022.

(51) Int. Cl. A01G 9/02

(52) U.S. Cl. CPC A01G 9/02; A01G 2009/003

(57) ABSTRACT

The present invention relates generally to the field of plant pots. More specifically, the present invention relates to a removable plant pot device. The device is primarily comprised of a body, further comprised of a first half and a second half, further connected via at least one peelable connection member. The peelable connection member is further comprised of at least one perforated edge and at least one pull tab that allows for easy separation between the two halves. The device is further comprised of a bottom wall that is comprised of at least one opening that allows for the plant to drain. The removable plant pot device allows users to pot and replant plants without damaging the pot or the plant. The device also allows users to pot and repot plants with minimal soil spillage.

### CROSS-REFERENCE TO RELATED APPLICATION

The present application claims priority to, and the benefit of, U.S. Provisional Application No. 63/344,684, which was filed on May 23, 2022, and is incorporated herein by reference in its entirety.

### FIELD OF THE INVENTION

The present invention relates generally to the field of plant pots. More specifically, the present invention relates to a removable plant pot device. The device is primarily comprised of a body, further comprised of a first half and a second half, further connected via at least one peelable connection member. The peelable connection member is further comprised of at least one perforated edge and at least one pull tab that allows for easy separation between the two halves. The device is further comprised of a bottom wall that is comprised of at least one opening that allows for the plant to drain. The removable plant pot device allows users to pot and replant plants without damaging the pot or the plant. The device also allows users to pot and repot plants with minimal soil spillage. Accordingly, the present disclosure makes specific reference thereto. Nonetheless, it is to be appreciated that aspects of the present invention are also equally applicable to other like applications, devices, and methods of manufacture.

### BACKGROUND

By way of background, gardeners and other individuals who have an interest in plants may have difficulty potting and replanting plants. Individuals must make deep cuts into large pots with shearers to move plants, this can cause damage to the plant and the pot and may also spill the soil. Gardeners often must cut the roots of the plants in order to remove them from the soil, which can extensively damage the plant if not done with great care. Separating the plant from the pot the plant is in requires extensive effort to ensure plant health.

Therefore, there exists a long-felt need in the art for a plant pot liner that easily peels away from a plant and plant roots. Also there exists a long-felt need in the art for a plant pot that does not require a user to cut roots or damage the plant. There also exists a long-felt need in the art for a plant pot that allows a user to remove a plant for replanting with minimal effort and minimal soil spillage.

The subject matter disclosed and claimed herein, in one embodiment thereof, comprises a removable plant pot device. The device is primarily comprised of a body, further comprised of a first half and a second half, further connected via at least one peelable connection member. The peelable connection member is further comprised of a perforated edge and pull tabs that allow for easy separation between the two halves such that the device can easily be removed from around a plant. The device is further comprised of a bottom wall which is comprised of at least one opening that allows for the plant to drain.

In this manner, the removable plant pot device of the present invention accomplishes all of the foregoing objectives and provides a novel way to easily pot and replant a plant without the possibility of damaging the pot or plant. Further, the device allows for a user to replant plants with minimal effort and minimal possibility of soil spillage.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a removable plant pot device. The device is primarily comprised of a body, further comprised of a first half and a second half, further connected via at least one peelable connection member. The peelable connection member is further comprised of at least one perforated edge and at least one pull tab that allows for easy separation between the two halves. The device is further comprised of a bottom wall that is comprised of at least one opening that allows for the plant to drain.

The device allows a user to repot plants with minimal effort. A user can pull the peelable connecting member splitting the two halves to reveal the soil and the plant. Further, the device allows a user to replant plants without damaging the plant or spilling soil by eliminating the need to dig out the plant using shearers.

Accordingly, the removable plant pot device of the present invention is particularly advantageous as it provides a novel way to easily pot and replant a plant without the possibility of damaging the pot or plant. Further, the device allows for a user to replant plants with minimal effort and minimal possibility of spilling soil. In this manner, the removable plant pot device overcomes the limitations of existing plant pots known in the art.

Numerous benefits and advantages of this device will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a removable plant pot device of the present invention in an unpeeled state in accordance with the disclosed architecture;

FIG. 2 illustrates a perspective view of one potential embodiment of a removable plant pot device of the present invention in a partially peeled state while surrounded by potted soil in accordance with the disclosed architecture;

FIG. 3 illustrates a perspective view of one potential embodiment of a removable plant pot device of the present invention in a completely unpeeled state in accordance with the disclosed architecture;

FIG. 4 illustrates a perspective view of one potential embodiment of a removable plant pot device of the present invention in a completely unpeeled state in accordance with the disclosed architecture; and

FIG. 5 illustrates a flowchart chart of one potential method of using one potential embodiment of the removable plant pot device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a plant pot liner that easily peels away from the plant and the roots. Also there exists a long-felt need in the art for a plant pot that does not require a user to cut the roots or damage the plant to repot the plant. There also exists a long-felt need in the art for a plant pot that allows a user to remove a plant for replanting with minimal effort and minimal spillage of the soil.

The present invention, in one exemplary embodiment, is comprised of a removable plant pot device. The device is primarily comprised of a body, further comprised of a first half and a second half, further connected via at least one peelable connection member. The peelable connection member is further comprised of at least one perforated edge and at least one pull tab that allows for easy separation between the two halves. The device is further comprised of a bottom wall that is comprised of at least one opening that allows for the plant to drain.

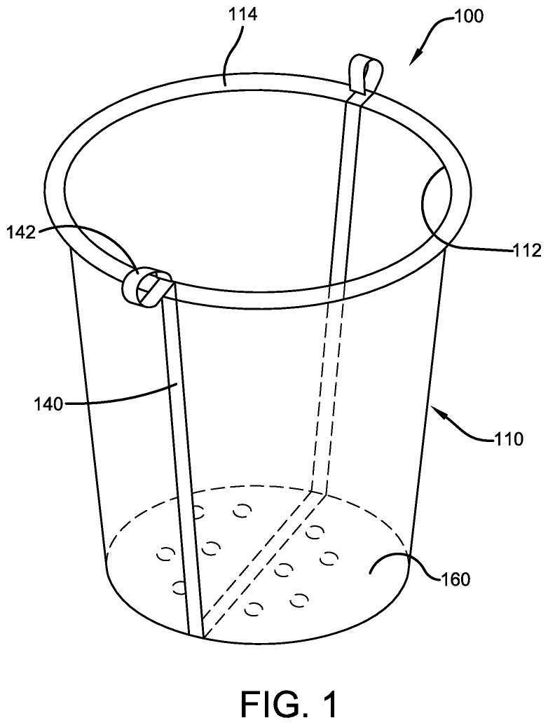

Referring initially to the drawings, FIG. 1 illustrates a perspective view of one potential embodiment of a removable plant pot device 100 of the present invention in an unpeeled state in accordance with the disclosed architecture. The device 100 is primarily comprised of a body 110, further comprised of a first half 120 and a second half 130 which are connected via at least one peelable connection member 140. The body 110 may be made from any material that is known to one skilled in the art, but in the preferred embodiment is made of a plastic material. The plastic material may be any plastic such as, but not limited to: acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, biodegradable plastic, etc. Further, the body 110 may be different sizes and shapes to accommodate a variety of different pot sizes and designs. The body 110 also is comprised of an opening 112 that allows for the plant and the soil to be placed into the device 100. The body also has a lip 114 at the top of the body 110 to allow the user to pull the device 100 out of the pot with minimal effort.

The body 110 is further comprised of at least two halves. In the preferred embodiment, the body 110 is comprised of a first half 120 and a second half 130. Both the first half 120 and the second half 130 are connected to the peelable connecting member 140. The peelable connecting member 140 is comprised of at least one pull tab 142 that allows a user to easily pull the peelable connecting member 140 to separate the halves 120,130 during replanting. The peelable connecting member 140 may be made from any material that is known to one in the art, but in the preferred embodiment the peelable connecting member 140 is made from a plastic material such as, but not limited to: acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, biodegradable plastic, etc. The device 100 also is comprised of a bottom wall 160, further comprised of at least one opening 170 to allow for the plant to drain the excess water.

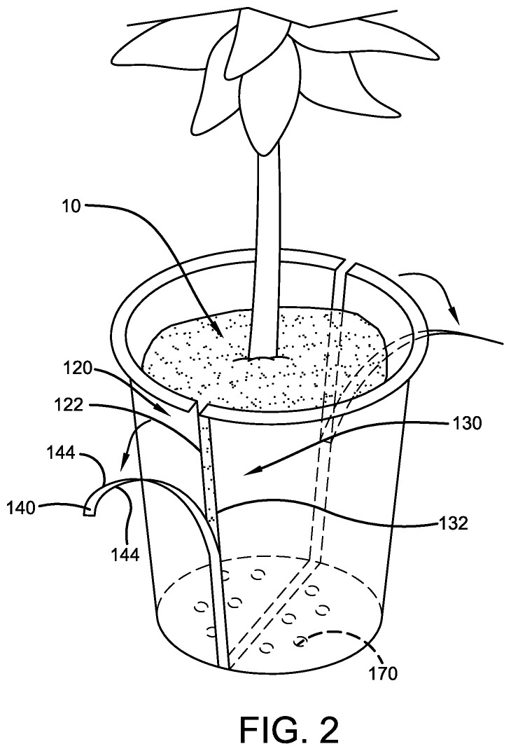

FIG. 2 illustrates a perspective view of one potential embodiment of a removable plant pot device 100 of the present invention in a partially peeled state while around potted soil 10. In the preferred embodiment, the body 110 is comprised of a first half 120 and a second half 130. In varying embodiments, the device 100 may be comprised of a multitude of pieces (i.e., halves) that are connected via a multitude of peelable connecting members 140. In the preferred embodiment, the first half is comprised of at least one perforated edge 122 that connects to the peelable connecting member 140. The second half is also comprised of at least one perforated edge 132 that is connected to the peelable connecting member 140. The peelable connecting member 140 is comprised of at least one perforated edge 144 that connects to the perforated edges 132, 122 of the first half 120 and the second half 130 of the body. These perforated edges 144, 132, 122 allow for the user to pull the peelable connecting member 140, causing the first half 120 and the second half 130 of the body 110 to separate, thus allowing the user to remove the device 100 from around a plant and replant said plant with minimal effort. The bottom wall 160 is comprised of at least one opening 170 to allow for the plant to drain the excess water.

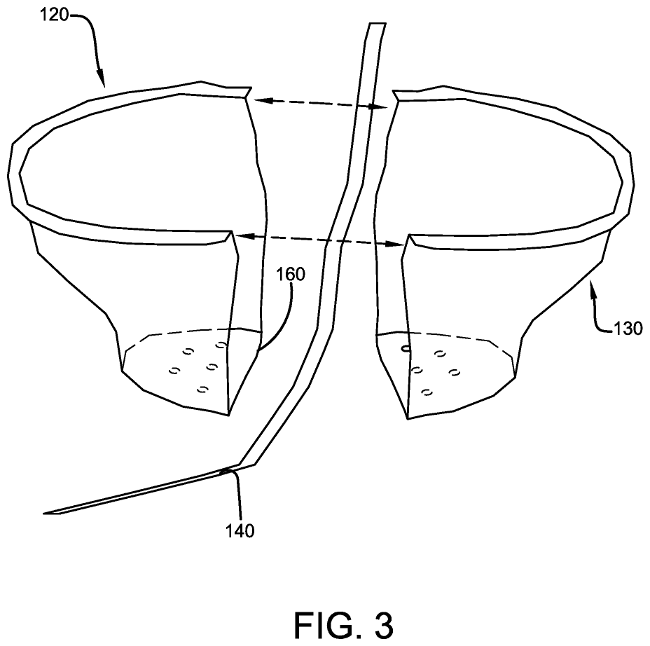

FIG. 3 illustrates a perspective view of one potential embodiment of a removable plant pot device 100 of the present invention in a completely unpeeled state. When the user pulls the peelable connecting member 140 using the pull tabs 142, the first half 120 and the second half 130 separate completely, including the bottom wall 160 via the perforated edges 144, 122, 132. This allows the plant to be removed without any damage, as well as minimal soil 10 spillage.

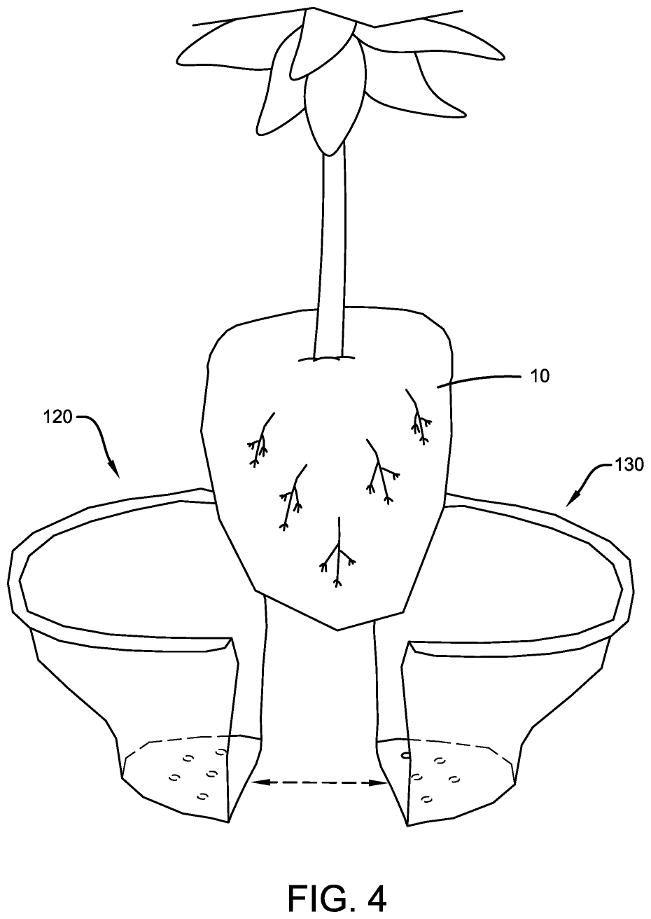

FIG. 4 illustrates a perspective view of one potential embodiment of a removable plant pot device 100 of the present invention in a completely unpeeled state. Once the first half 120 and the second half 130 of the body 110 have been completely separated via the peelable connecting member 140, the two halves can be removed, leaving only the soil 10 and the plant remaining. The plant and the soil 10 can then be replanted without damaging the plant or the roots in any way.

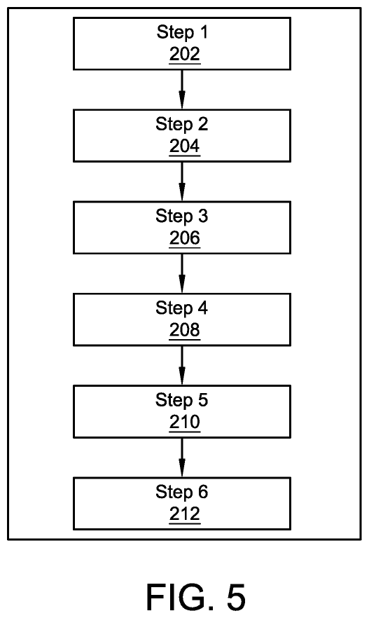

FIG. 5 illustrates a flowchart chart of one potential method 200 of using one potential embodiment of a removable plant pot device 100. First, a user can place the device 100 in the pot the user wishes to plant a plant into [Step 202]. Then, the user can place the plant and the soil 10 into the opening 112 of the device 100 [Step 204]. Next, when the user wishes to replant the plant, the user can remove the device 100 from the pot by grabbing on the lip 114 and pulling up on the device 100 [Step 206]. Then, the user can pull on the pull tabs 142, which will pull the peelable connecting member 140 ripping down the perforated edges 142, 132, 122 [Step 208]. As the user pulls on the pull tabs 142, the first half 120 and the second half 130 will separate allowing the user to pull the two halves away from the soil [Step 210]. Finally, the user can take the plant with the soil and conveniently replant the plant where the user sees fit [Step 212].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “removable plant pot device” and “device” are interchangeable and refer to the removable plant pot device 100 of the present invention.

Notwithstanding the foregoing, the removable plant pot device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the removable plant pot device 100 as shown in the FIGS. are for illustrative purposes only, and that many other sizes and shapes of the removable plant pot device 100 are well within the scope of the present disclosure. Although the dimensions of the removable plant pot device 100 are important design parameters for user convenience, the removable plant pot device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A removable plant pot device comprising:
a first half;
a second half;
a bottom wall;
a peelable connecting member;
an opening; and
a lip.

2. The removable plant pot device of claim 1, wherein the first half attaches to the peelable connecting member.

3. The removable plant pot device of claim 1, wherein the second half attaches to the peelable connecting member.

4. The removable plant pot device of claim 1, wherein the peelable connecting member attaches to the bottom wall.

5. The removable plant pot device of claim 1, wherein the bottom wall is comprised of an opening.

6. The removable plant pot device of claim 1, wherein the removable plant pot device is comprised of a biodegradable material.

7. The removable plant pot device of claim 1, wherein the removable plant pot device is comprised of a biodegradable plastic material.

8. The removable plant pot device of claim 7 further comprising a tab.

9. A removable plant pot device comprising:
a first half comprised of a perforated edge;
a second half comprised of a perforated edge;
a bottom wall;
a peelable connecting member comprised of a first perforated edge and a second perforated edge;
an opening; and
a lip.

10. The removable plant pot device of claim 9, wherein the first perforated edge of the peelable connecting member is attached to the perforated edge of the first half.

11. The removable plant pot device of claim 9, wherein the second perforated edge of the peelable connecting member is attached to the perforated edge of the second half.

12. The removable plant pot device of claim 9, wherein the peelable connecting member is further comprised of a pull tab.

13. The removable plant pot device of claim 9, wherein the bottom wall is comprised of an opening.

14. The removable plant pot device of claim 9, wherein the removable plant pot device is comprised of a biodegradable plastic material.

15. The removable plant pot device of claim 9, wherein the removable plant pot device is comprised of a biodegradable material.

16. A method of using a removable plant pot device, the method comprising the steps of:
placing the removable plant pot device in a pot;
placing a plant and a soil into the removable plant pot device via an opening in the removable plant pot device;
removing the removable plant pot device from the pot by grabbing a lip of the opening and pulling upwards on the removable plant pot device; and
pulling on a pull tab of a peelable connecting member of the removable plant pot device.

17. The method claim 16, wherein puling the pull tab removes the peelable connecting member from the removable plant pot device.

18. The method of claim 17, wherein removing the peelable connecting member from the removable plant pot device separates the removable plant pot device into a first half and a second half.

19. The method of claim 18, wherein the removable plant pot device is comprised of a biodegradable plastic material.

20. The method of claim 18, wherein the removable plant pot device is comprised of a biodegradable material.
